(19) United States
(12) Patent Application Publication
(10) Pub. No.: US 2011/0170582 A1
(43) Pub. Date: Jul. 14, 2011

(54) APPARATUS AND METHOD FOR DOWNCONVERTING RF MULTI-SIGNALS SIMULTANEOUSLY BY BANDPASS SAMPLING

(75) Inventors: Jin Woo Park, Seoul (KR); Junghwa Bae, Seoul (KR)

(73) Assignee: Jin Woo Park, Seoul (KR)

(21) Appl. No.: 12/514,369

(22) PCT Filed: Nov. 6, 2007
(86) PCT No.: PCT/KR2007/005582

§ 371 Date: Dec. 14, 2009

(30) Foreign Application Priority Data
Nov. 10, 2006 (KR) 10-2006-0110982

(51) Int. Cl. H04L 27/08; H04B 17/00

(52) U.S. Cl. 375/224; 375/345

(57) ABSTRACT

The present invention relates to a method of down-converting RF multi-signals by bandpass sampling, which includes: setting up obtainable combinations of 2 spectrum signals extracted from 2N negative and positive spectrum signals existing for N RF signals; calculating available sampling ranges for the 2 spectrum signals in each obtainable combination; and determining an effective sampling range by the intersection of the available sampling ranges.

### TECHNICAL FIELD

The present invention relates to an apparatus and a method for down-converting radio frequency (RF) multi-signals, and more particularly, to an apparatus and a method for down-converting RF multi-signals simultaneously by a bandpass sampling.

### BACKGROUND ART

Recently, various wireless device, which may be referred to as an RF devices, using digital technology have newly emerged with a great advance in a semiconductor device technologies. In addition, the signal processing technologies for high speed wireless communications have developed significantly. Therefore, the wireless communication systems based on digital technologies can now guarantee higher performance as well as higher level of flexibility and adaptability as compared with the conventional wireless systems based on analog technologies.

A representative example of such technology trend is a software-defined radio (SDR) system, in which most of the signal processing is carried out in software. In the SDR system, an analog signal received by an antenna is directly converted into a digital signal and then the digitalized signal is processed in software. As a result, the necessity of analog devices which are in general expensive and limited in functions, such as a mixer, a local oscillator and a filter, can be minimized.

When a specific signal among a plurality of RF signals is selected to be received, some changes in an analog hardware related to RF tuning are required in the analog system. Accordingly, the structure becomes complicated, the cost increases and a usage time of a battery is reduced in the analog system. In contrast, the SDR system requires simple change in the parameters of a software and execution of the software, so that the SDR system has much greater advantages in flexible utilization and economic feasibility.

FIG. 1 is a block diagram showing a receiver structure of a conventional SDR system according to the related art. In FIG. 1, after a signal received by a broadband antenna 100 is amplified through a low noise amplifier (LNA) 101, a signal spectrum passes through a bandpass filter 102 in order to suppress other interfering signals and noises. When the other signal is to be received, the center frequency and the passband bandwidth of the bandpass filter 102 should be changed to a new center frequency with a new bandwidth depending on the desired signal spectrum.

An input analog signal is converted into a digital signal by an analog to digital (A/D) converter 103, and such digitalized signal is demodulated and restored by a digital signal processor (DSP) 104. Then the sending signal is detected.

In particular, the A/D converter 103 performs two conversion functions, which are the signal format conversion where an analog signal is converted into a digital signal and the frequency down-conversion function where an RF passband signal is converted into a baseband signal. This conversion by an A/D converter is referred to as a bandpass sampling.

When the Nyquist theory is applied to a sampling process, the resulting sampling rate should be greater than twice of the maximum frequency of a target signal spectrum. Accordingly, when a conventional sampling based on the Nyquist theory is applied to an RF signal having a carrier frequency of several hundreds kHz to several GHz, a required sampling frequency becomes great and the size of digitalized signals can be too large for the DSP 104 to handle and also the DSP 104 consumes too much power for further processing.

In the bandpass sampling, an RF bandpass signal can be converted into a baseband signal with a sampling rate much lower than a Nyquist sampling rate. Accordingly, the realization of an efficient bandpass sampling has been an important subject in implementing a SDR system. Note that a low sampling rate reduces an amount of the digitalized signal samples. Accordingly, a load in a subsequent digital signal processing steps is reduced and the power consumption of a digital signal processor can also be improved, thereby extending a usage time of a battery.

However, since the bandpass sampling does not follow Nyquist theory, the sampling rate of the bandpass sampling should be determined not to allow any overlap between a lower sideband and a higher sideband of the target signal spectrums in the resulting down-converted signal. Especially, when a plurality of RF signals are down-converted simultaneously, finding a minimum sampling rate that guarantees a successful down-conversion of multiple RF signals is an important task for implementing an efficient SDR receivers because a large number of lower sideband signals and higher sideband signals exist.

### DISCLOSURE OF INVENTION

### Technical Problem

Accordingly, an object of the present invention is to provide an apparatus and a method for down-converting multiple RF signals simultaneously by a bandpass sampling, in which a method of finding a minimum sampling rate is included.

In addition, another object of the present invention is to provide an apparatus and a method for down-converting RF multi-signals simultaneously by a bandpass sampling, where an effective sampling range is calculated and a minimum sampling frequency is selected using the calculated effective sampling range.

### Technical Solution

To achieve these and other advantages and in accordance with the purpose of embodiments of the invention, as embodied and broadly described, an apparatus of down-converting RF multi-signals by bandpass sampling includes: a broadband low noise amplifier amplifying N RF signals received by a broadband antenna N bandpass filters, each of which is centered at the carrier frequency with a signal bandwidth as specified by the communication standards, filtering the N RF signals amplified by the broadband low noise amplifier in order to suppress other interfering signals and noises and an analog to digital converter determining an effective sampling range for the N RF signals and selecting a sampling frequency in the effective sampling range to perform the bandpass sampling.

In another aspect, a method of down-converting RF multi-signals by bandpass sampling includes: setting up obtainable combinations of 2 spectrum signals extracted from 2N negative and positive spectrum signals existing for N RF signals; calculating available sampling ranges for the 2 spectrum signals in each obtainable combination; and determining an effective sampling range by an intersection of the available sampling ranges.

The present invention provides a method of positioning a plurality of RF spectrums emitted from a plurality of wireless communication systems each using a respective carrier frequency at a baseband by down-converting simultaneously. Specifically, the present invention provides a method of calculating an effective sampling frequency range required for a bandpass sampling for down-conversion and a method of selecting a minimum sampling frequency using the effective sampling frequency range when the bandpass sampling for down-conversion is performed.

### Advantageous Effects

According to the present invention, in a bandpass sampling necessary to an SDR system, a single wireless apparatus simultaneously receives N wireless communication standards and selects a desired signal by down-conversion into a baseband.

Further, according to the present invention, in a simultaneous down-conversion of N signals, the signals are processed in an intermediate frequency (IF) region without a distortion such as aliasing due to overlap of signals even when a sampling frequency having a sampling rate much lower than that of Nyquist is selected.

### BRIEF DESCRIPTION OF THE DRAWINGS

FIG. 1 is a block diagram showing a receiver structure of a SDR system according to the related art.

FIG. 2 is a block diagram showing a receiver structure of a software-defined radio (SDR) system for down-conversion of N signals according to an embodiment of the present invention.

FIG. 3 is a view showing arrangement of N signals in negative and positive frequency regions according to an embodiment of the present invention.

FIG. 4 is a view showing N RF spectrum signals with parameters according to an embodiment of the present invention.

FIG. 5 is a view showing 2 RF spectrum signals according to an embodiment of the present invention.

FIG. 6 is a view showing down-converted signals from 2 RF spectrum signals by bandpass sampling according to an embodiment of the present invention.

FIG. 7 is a view showing a spectrum of 2 RF spectrum signals according to an embodiment of the present invention.

FIG. 8 is a view showing a spectrum of down-converted signals from 2 RF spectrum signals of FIG. 7 by bandpass sampling according to an embodiment of the present invention.

FIG. 9 is a view showing a spectrum of 3 RF spectrum signals according to an embodiment of the present invention.

FIG. 10 is a view showing a spectrum of down-converted signals from 3 RF spectrum signals of FIG. 9 by bandpass sampling according to an embodiment of the present invention.

FIG. 11 is a view showing a spectrum of down-converted signals from N RF spectrum signals by bandpass sampling according to an embodiment of the present invention.

FIG. 12 is a flow chart showing a method of down-converting RF spectrum signals simultaneously by bandpass sampling according to an embodiment of the present invention.

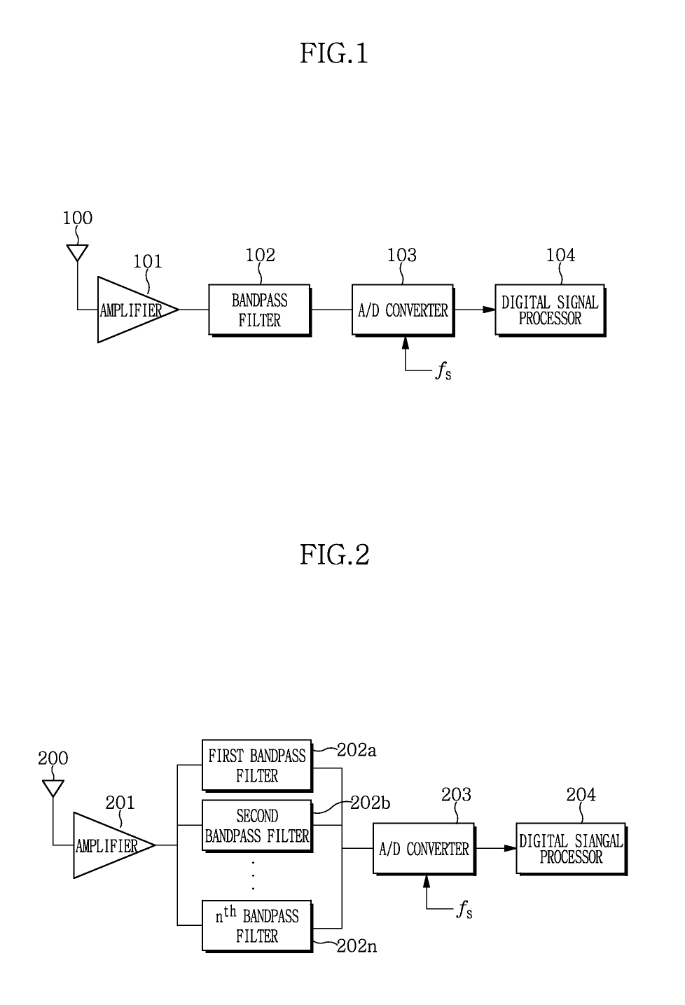

### ILLUSTRATION OF REFERENCE NUMBERS FOR PRINCIPAL PARTS OF DRAWINGS

100, 200: broadband antenna
101, 201: amplifier
102, 202: bandpass filter
103, 203: A/D converter
104, 204: digital signal processor

### MODE FOR THE INVENTION

Reference will now be made in detail to the illustrated embodiments of the invention, examples of which are illustrated in the accompanying drawings. However, illustration about a related art function and a related art structure that may cause unnecessary confusion in the subject matter of the present invention will be omitted.

FIG. 2 is a block diagram showing a receiver structure of a software-defined radio (SDR) system for down-conversion of N signals according to an embodiment of the present invention.

In FIG. 2, a receiver of an SDR system for down-conversion of N signals includes a broadband antenna 200, an amplifier 201, N bandpass filters 202, an analog to digital (A/D) converter 203 and a digital signal processor 204. Since the receiver down-converts N signals simultaneously, N bandpass filters 202 each corresponding to a carrier frequency allocated by each communication standards and a bandwidth of each signal are required in the receiver.

Before a method of calculating an effective sampling range according to the present invention is illustrated, the parameters used are defined in the following contents.

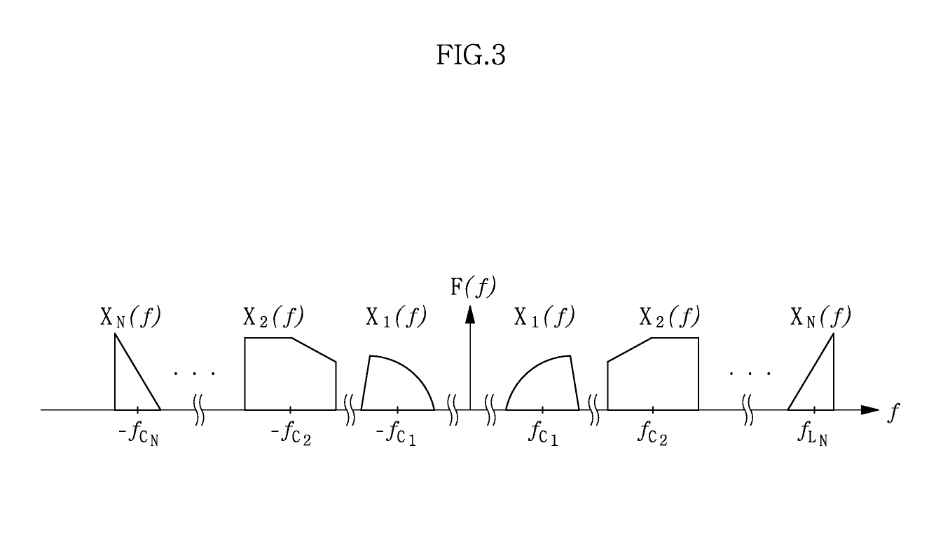

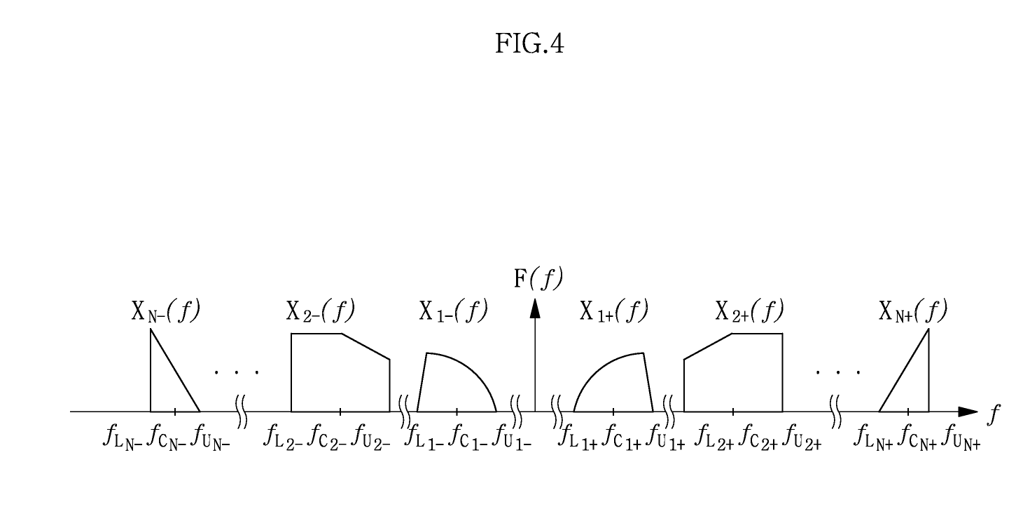

FIG. 3 is a view showing arrangement of N signals in negative and positive frequency regions according to an embodiment of the present invention, and FIG. 4 is a view showing N RF spectrum signals with parameters according to an embodiment of the present invention.

In FIG. 3, N bandpass signals Xₖ(f) (k=1, 1, . . . , N) are arranged such that each signal is positioned centered at an individual carrier frequency without an overlap between spectrums. Parameters for the N signals, i.e., a sampling frequency, a carrier frequency for a signal Xₖ(f), an upper limit frequency, a lower limit frequency, an intermediate frequency and a bandwidth are designated by f_{S}, f_{C}_{ₖ}, f_{U}_{ₖ}, f_{L}_{ₖ}, f_{IF}_{ₖ}, BWₖ, respectively. The upper limit frequency and the lower limit frequency may be expressed as

f_{U}_{ₖ}=f_{C}_{ₖ}+(BWₖ/2)

and

f_{L}_{ₖ}=f_{C}_{ₖ}−(BWₖ/2),

respectively, and the carrier frequencies are assumed to satisfy a relation of

f_{C}_{ᵢ}<f_{C}_{ᵢ₊₁}

(i=1, 2, . . . , N−1).

Referring to FIGS. 3 and 4, a single signal Xₖ(f) includes two RF spectrum signals, i.e., an element of a positive frequency region Xₖ₊(f) and an element of a negative frequency region Xₖ₋(f). Here, position elements of parameters can be represented as

f_{L}_{_{k−}}=−f_{U}_{ₖ},
f_{C}_{_{k−}}=−f_{C}_{ₖ},
f_{U}_{_{k−}}=−f_{L}_{ₖ},
f_{L}_{ₖ₊}=f_{L}_{ₖ}
f_{C}_{ₖ₊}=f_{C}_{ₖ}
and
f_{U}_{ₖ₊}=f_{U}_{ₖ}
(k=1, 2, . . . , N). Accordingly, the carrier frequencies for the RF signals satisfy a relation

f_{C}_{_{N−}}<f_{C}_{_{(N−1)−}}< . . . <f_{C1-}f_{C1+}< . . . <f_{C(N-1)+}<f_{C}_{_{N+}}.

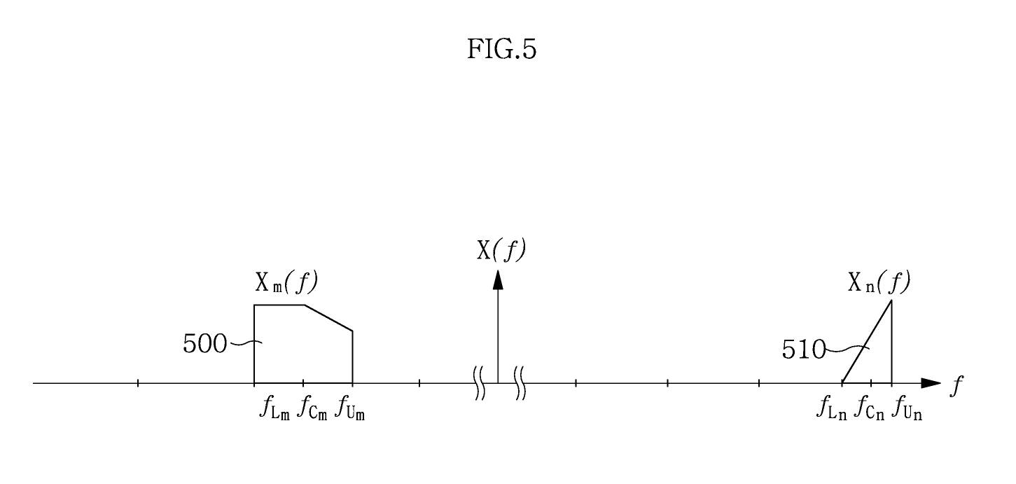

As shown in FIG. 5, for the purpose of deriving a general formula for an effective sampling frequency range for down-conversion of N signals, a range of an effective sampling frequency about arbitrary two RF spectrum signals, i.e., Xₘ(f) 500 and Xₙ(f) 510 is calculated. Here, the carrier frequencies for the two RF spectrum signals satisfy a relation of

f_{C}_{ₘ}<f_{C}_{ₙ}, m,nε{1±,2±, . . . ,N±}

in accordance with the above assumption.

When a bandpass sampling is performed for the two RF spectrum signals shown in FIG. 5, an effective sampling frequency range where down-converted signals do not overlap each other should satisfy the following two conditions at the same time.

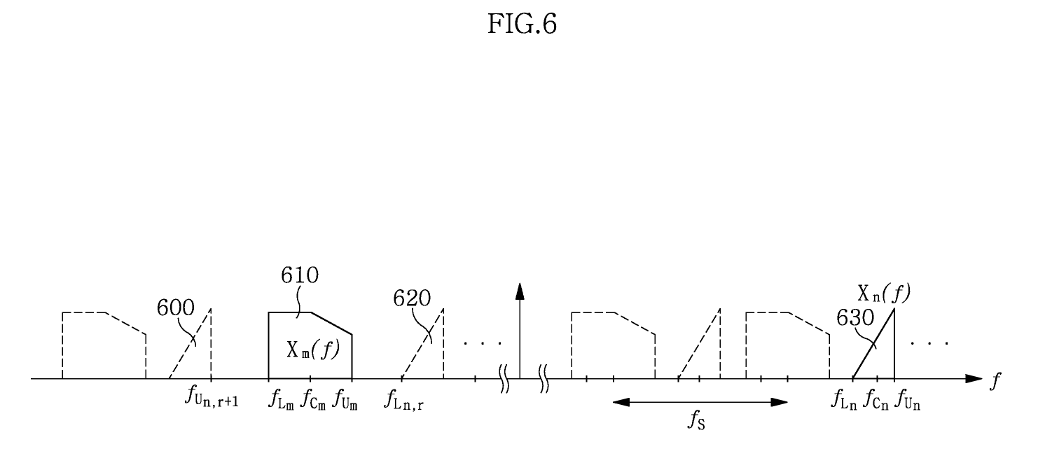

As the first condition there is a limit to an upper value of a sampling frequency, i.e., as shown in FIG. 6, f_{L}_{_{n,r}} of a signal 620 which is moved left by (r_{m,n})^{th} from one RF spectrum signal Xₙ(f) 630 should be greater than f_{U}_{ₘ} of the other RF spectrum signal Xₘ(f) 61.

As the second condition there is a limit to a lower value of a sampling frequency, i.e., f_{U}_{_{n,r+1}} of a signal 600 which is moved left by (r_{m,n+1})^{th} from one RF spectrum signal Xₙ(f) 630 should be smaller than f_{L}_{ₘ} of the other RF spectrum signal Xₘ(f) 610.

The above two conditions may be expressed as the following equations 1 and 2.

$$\begin{matrix}{f}_{{C}_{n}} - \frac{{BW}_{n}}{2} - {r}_{m , n} {f}_{s} \geq {f}_{{C}_{m}} + \frac{{BW}_{m}}{2} & [ Equation 1 ] \\ {f}_{{C}_{n}} + \frac{{BW}_{n}}{2} - ( {r}_{m , n} + 1 ) {f}_{s} \leq {f}_{{C}_{m}} - \frac{{BW}_{m}}{2} & [ Equation 2 ]\end{matrix}$$

Equation 3 is obtained by adding equations 1 and 2.

$$\begin{matrix}\frac{{f}_{{C}_{n - m}} + ( {BW}_{m + n} / 2 )}{{r}_{m , n} + 1} \leq {f}_{{S}_{m , n}} \leq \frac{{f}_{{C}_{n - m}} - ( {BW}_{m + n} / 2 )}{{r}_{m , n}} , \\ where \\ {f}_{{C}_{n - m}} = {f}_{{C}_{n}} - {f}_{{C}_{m}} , {BW}_{m + n} = {BW}_{m} + {BW}_{n} ,\end{matrix} \qquad [ Equation 3 ]$$

and r_{m,n} is an integer limited by the following equation 4.

$$0 \leq {r}_{m , n} \leq ⌊ \frac{{f}_{{C}_{n - m}} - ( {BW}_{m + n} / 2 )}{{BW}_{m + n}} ⌋ \qquad [ Equation 4 ]$$

Here, r_{m,n} represents a positioning rate of a bandwidth sum BWₘ₊ₙ of the two RF spectrum signals between the two RF spectrum signals, i.e.,

f_{L}_{ₙ}−f_{U}

without overlap. Accordingly, as r_{m,n} increases, the obtained sampling frequency decreases.

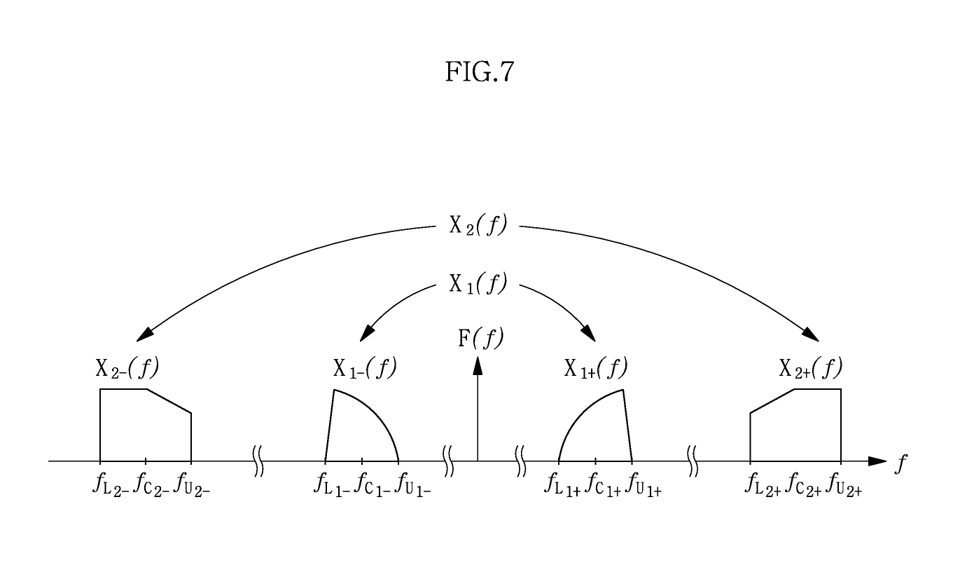

An effective sampling range for the two RF spectrum signals Xₘ(f) and Xₙ(f) is calculated from equation 3. As shown in FIG. 7, two signals X₁₊(f) and X₁₋(f) exist in an effective sampling range for the first RF spectrum signal X1(f) of a signal spectrum. As a result, the following equation 5 is obtained based on

f_{C}_{₁₊}=f_{C}_{₁}, f_{C}_{_{1−}}=f_{C}_{₁}

### and BW₁₊=BW₁₋=BW₁.

$$\frac{2 {f}_{{U}_{1}}}{{r}_{1 - , 1 +} + 1} \leq {f}_{{S}_{1 - , 1 +}} \leq \frac{2 {f}_{{L}_{1}}}{{r}_{1 - , 1 +}} \qquad [ Equation 5 ]$$

Here, a range of r_{1-,1+} is obtained from the equation 4 as.

0≦r_{1-,1+≦}└f_{L}_{₁}/BW₁┘

A method of calculating an effective sampling range in a system where two communication standards are down-converted simultaneously will be illustrated hereinafter. In a spectrum for two signals, as shown in FIG. 7, two spectrum elements exist in each of negative and positive frequency regions. Accordingly, four RF spectrum signals X₂₋(f), X₁₋(f), X₁₊(f) and X₂₊(f) exist in the spectrum for the two signals.

A frequency region, where the four RF spectrum signals do not collide with each other, while a bandpass sampling is performed, is selected as an effective sampling range. Accordingly, all available sampling ranges for the two RF spectrum signals are calculated from combinations of the four RF spectrum signals.

For example, based on equation 3, an available sampling range f_{S}_{_{2−,1−}} of X₂₋(f) and X₁₋(f), an available sampling range fs_{2-,1+} of X₂₋(f) and X₁₊(f), an available sampling range f_{S}_{_{2−,2+}} of X₂₋(f) and X₂₊(f), an available sampling range f_{S}_{_{1−,1+}} of X₁₋(f) and X₁₊(f), an available sampling range f_{S}_{_{1−,2+}} of X₁₋(f) and X₂₊(f) and an available sampling range f_{S}_{_{1+,2+}} of X₁₊(f) and X₂₊(f) may be calculated (₄C₂=6 ranges).

Next, the effective sampling range for two communication standards is obtained by calculating overlap portions of the 6 ranges. Accordingly, the effective sampling range may be expressed as the following equation 6.

f_{S,two}=f_{S}_{_{2−,1−}} [symbol] f_{S}_{_{2−,1−}} [symbol] f_{S}_{_{2−,2+}} [symbol] f_{S}_{_{1−,1+}} [symbol] f_{S}_{_{1−,2+}} [symbol] f_{S}_{_{1+,2+}} [Equation 6]

In equation 6, an intersection ∩ represents an overlap portion of two ranges. In addition, the minimum value in the obtained effective sampling range is selected as a minimum sampling frequency. As a result, the minimum sampling frequency is expressed as the following equation 7.

f_{S,two,min}+min{f_{S,two}} [Equation 7]

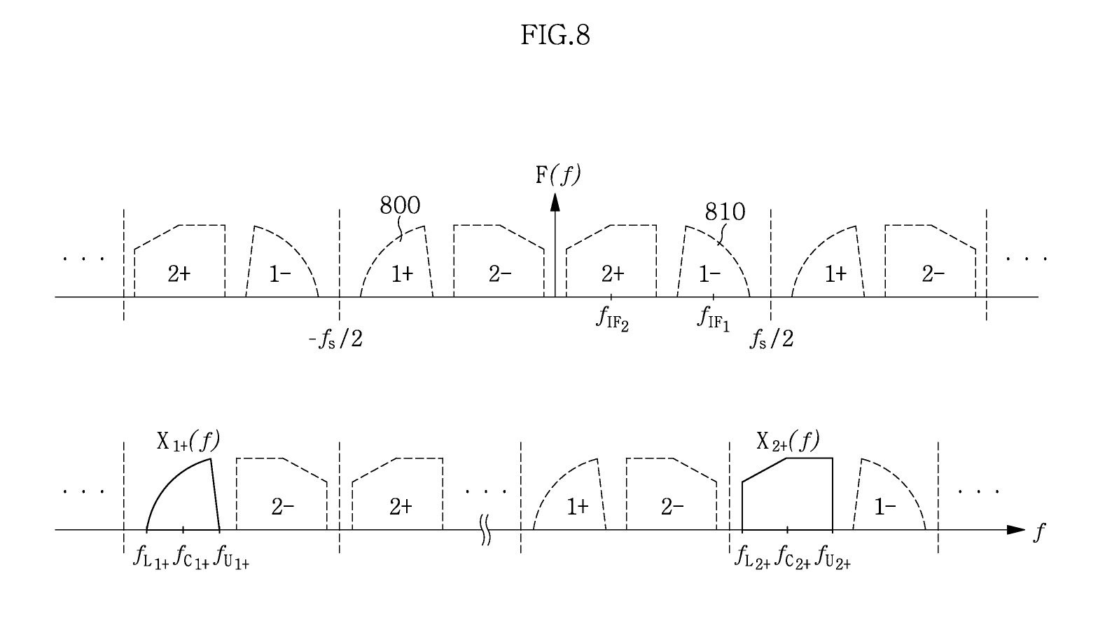

FIG. 8 is an exemplary spectrum of signals which is down-converted in an available sampling range obtained from equation 6 using an arbitrary sampling frequency f_{S}.

As shown in FIG. 8, positions of signals is changed according to the sampling frequency f_{S} in an intermediate frequency (IF) region. As a result, the frequency of each signal in the IF region is obtained by the following equation 8.

$${F}_{k} = ⌊ \frac{{f}_{{C}_{k}}}{{f}_{S} / 2} ⌋ is \{ \begin{matrix}even \text{:} {f}_{{IF}_{k}} = rem ( {f}_{{C}_{k}} , {f}_{S} ) \\ odd \text{:} {f}_{{IF}_{k}} = {f}_{S} - rem ( {f}_{{C}_{k}} , {f}_{S} ) ,\end{matrix} \\ where \\ rem ( {f}_{{C}_{k}} , {f}_{S} ) \qquad [ Equation 8 ]$$

represents a remainder when dividing f_{C}_{ₖ} by f_{S}.

Accordingly, the positions of signals in the IF region may be changed each other from the positions in the RF region. In addition, when Fₖ of the equation 8 is an odd number, the spectrums of signals may be inverted in the IF region as reference numbers 800 and 810 of FIG. 8.

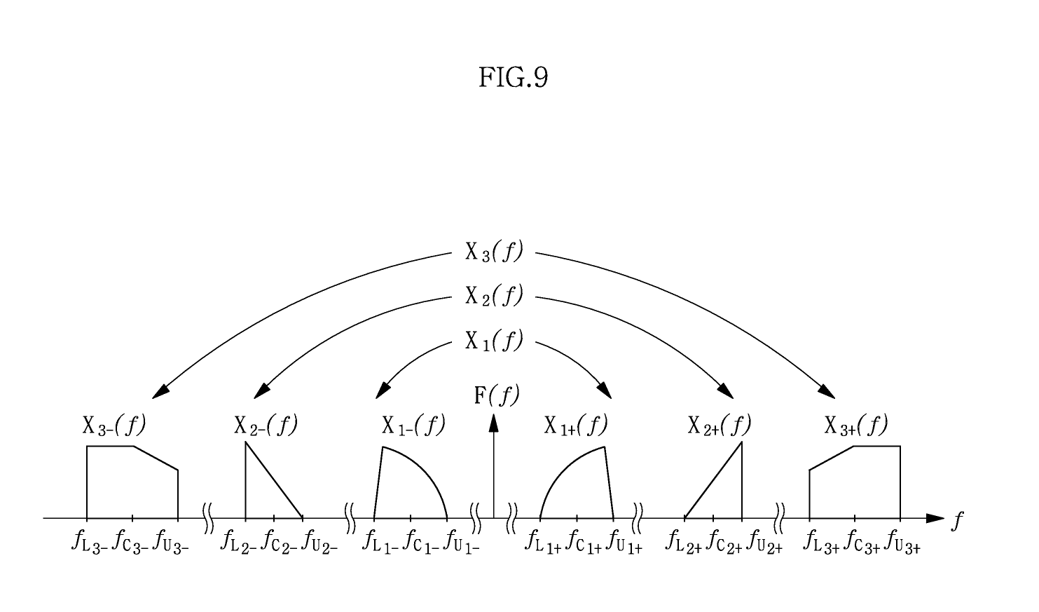

Next, a system where three signals are down-converted simultaneously will be illustrated hereinafter according to an embodiment of the present invention. As shown in FIG. 9, since six RF spectrum signals X₃₋(f), X₂₋(f), X₁₋(f), X₁₊(f), X₂₊(f) and X₃₊(f) exist, a frequency range where the six RF spectrum signals do not overlap each other is selected as an effective sampling range.

Accordingly, fifteen (₆C₂=15) available sampling ranges f_{S}_{_{m,n}} (where m,n ε1±, 2±, . . . , N±) are required. An effective sampling range for three RF spectrum signals based on the equation 6 is expressed as the following equation 9.

f_{S,three}=f_{S}_{_{3−,2−}} [symbol] f_{S}_{_{3−,1−}} [symbol] f_{S}_{_{3−,1+}} [symbol] f_{S}_{_{3−,2+}} [symbol] f_{S}_{_{3−,3+}} [symbol] f_{S}_{_{2−,1−}} [symbol] f_{S}_{_{2−,1+}} [symbol] f_{S}_{_{2−,2+}} [symbol] f_{S}_{_{2−,3+}} [symbol] f_{S}_{_{1−1+}} [symbol] f_{S}_{_{1−,2+}} [symbol] f_{S}_{_{1−3+}} [symbol] f_{S}_{_{1+,2+}} [symbol] f_{S}_{_{1+,3+}} [symbol] f_{S}_{_{2+,3+}} [Equation 9]

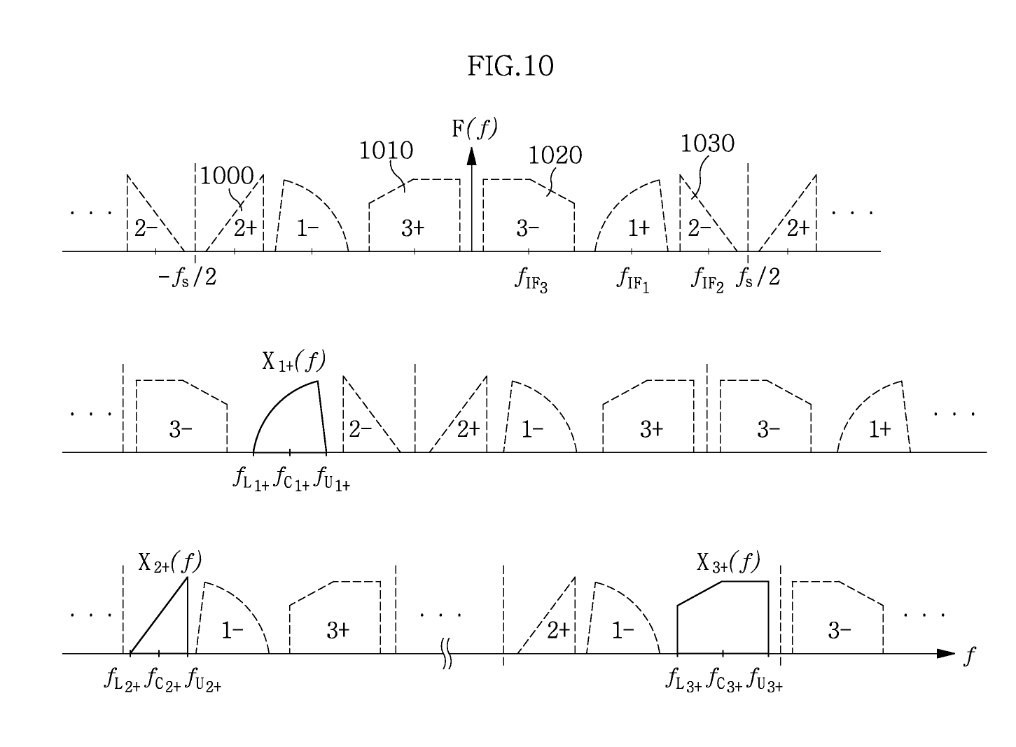

FIG. 10 is an exemplary spectrum which is down-converted in an available sampling range obtained from equation 9 using an arbitrary sampling frequency f_{S}. As in the above example, the spectrums of signals may be inverted according to the sampling frequency f_{S} as reference numbers 100, 101, 102 and 103 of second and third spectrum signals X₂(f) and X₃(f). In addition, positions of signals may be changed with each other.

A generalized effective sampling frequency range may be expressed as the following equation 10 by extending the above procedure of calculating an effective sampling frequency range for two or three signals to N signals.

$${f}_{S , all} = {f}_{{S}_{N -}} ⋂ {f}_{{S}_{( N - 1 ) -}} ⋂ … ⋂ {f}_{{S}_{1 -}} ⋂ {f}_{{S}_{1 +}} ⋂ … ⋂ {f}_{{S}_{( N - 1 ) +}} , \\ where \\ {f}_{{s}_{N -}} = ( {⋂}_{k = ( N - 1 ) -}^{1 -} {f}_{{S}_{N - , k}} ) ⋂ ( {⋂}_{k = 1 +}^{N +} {f}_{{S}_{N - , k}} ) , \\ {f}_{{S}_{1 -}} = {⋂}_{k = 1 +}^{N +} {f}_{{S}_{1 - , k}} , \\ {f}_{{S}_{1 +}} = {⋂}_{k = 2 +}^{N +} {f}_{{S}_{1 + , k}} , and \\ {f}_{{S}_{( N - 1 ) +}} = {f}_{{S}_{( N - 1 ) + , N +}} \qquad [ Equation 10 ]$$

Accordingly, after sampling ranges for m,nε{1±, 2±, . . . , N±} signals, that is, all combinations of two RF spectrum signals from 2N RF spectrum signals, are obtained from the equation 3, an overlapped portion of the sampling ranges is calculated as an effective sampling range by the equation 10.

As a result, a total number of the sampling ranges f_{S}_{_{m,n}} of the equation 3 necessary to the equation 10 equals to _{2N}C₂=(2N!)/{(2N−2)!2!}, that is, the number of combinations of two spectrum signals extracted from 2N spectrum signals.

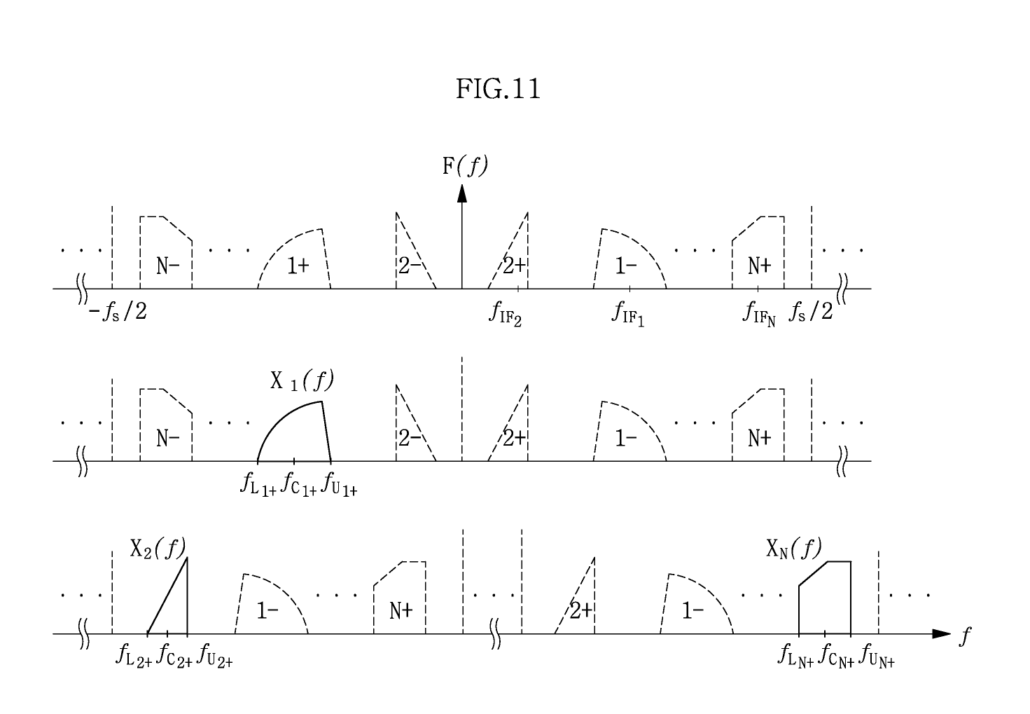

FIG. 11 is an exemplary spectrum of N signals which is down-converted using a bandpass sampling frequency. In addition, the value of f_{S,min}=min{f_{S,all}}, that is, the minimum value among frequencies in an effective sampling range obtained from the above procedure, is selected as a minimum sampling frequency.

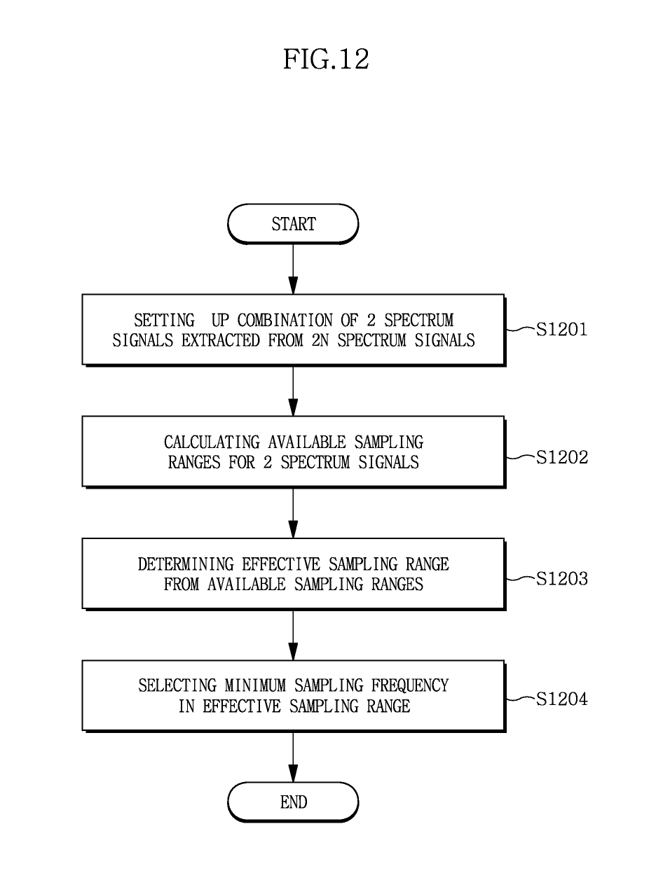

FIG. 12 is a flow chart showing a method of down-converting RF spectrum signals simultaneously by bandpass sampling according to an embodiment of the present invention.

As shown in FIG. 12, for the purpose of down-converting N RF signals simultaneously by bandpass sampling, obtainable combinations of two spectrum signals extracted from 2N negative and positive spectrum signals existing for N RF signals are set up first (S1201).

Next, available sampling ranges for the two spectrum signals are calculated by the equation 3 in each obtainable combination (S1202). Next, an effective sampling range is determined by an intersection of the available sampling ranges calculated from the obtainable combinations (S1203).

Finally, the minimum value of frequencies in the effective sampling range is selected as the minimum sampling frequency (S1204).

It will be apparent to those skilled in the art that various modifications and variations can be made in the apparatus and the method of down-converting RF multi-signals simultaneously by bandpass sampling of embodiments of the invention without departing from the spirit or scope of the invention. Thus, it is intended that embodiments of the invention cover the modifications and variations of this invention provided they come within the scope of the appended claims and their equivalents.

1. An apparatus of down-converting RF multi-signals by bandpass sampling, comprising:
a broadband low noise amplifier amplifying N RF signals received by a broadband antenna
N filters filtering the N RF signals amplified by the broadband low noise amplifier according to a carrier frequency allocated by each communication standards and a bandwidth of each signal and
an analog to digital converter determining an effective sampling range for the N RF signals and selecting a sampling frequency in the effective sampling range to perform the bandpass sampling.

2. The apparatus of down-converting RF multi-signals by bandpass sampling according to claim 1, wherein the analog to digital converter selects a minimum value of frequencies in the effective sampling range as a minimum sampling frequency to perform the bandpass sampling.

3. The apparatus of down-converting RF multi-signals by bandpass sampling according to claim 1, wherein the analog to digital converter determines the effective sampling range by setting up obtainable combinations of 2 spectrum signals extracted from 2N negative and positive spectrum signals existing for the N RF signals, calculating available sampling ranges for the 2 spectrum signals in each obtainable combination and determining the effective sampling range by an intersection of the available sampling ranges.

4. The apparatus of down-converting RF multi-signals by bandpass sampling according to claim 3, wherein when a first signal among the 2 spectrum signals disposed right in a frequency spectrum is moved left by a predetermined number, a lower limit frequency of the first signal is greater than an upper limit frequency of a second signal among the 2 spectrum signals disposed left in the frequency spectrum.

5. The apparatus of down-converting RF multi-signals by bandpass sampling according to claim 3, wherein when a first signal among the 2 spectrum signals disposed right in a frequency spectrum is moved left by a predetermined number, an upper limit frequency of the first signal is smaller than a lower limit frequency of a second signal among the 2 spectrum signals disposed left in the frequency spectrum.

6. The apparatus of down-converting RF multi-signals by bandpass sampling according to claim 3, wherein the number of the obtainable combinations is _{2N}C₂=(2N!)/{(2N−2)!2 !}.

7. The apparatus of down-converting RF multi-signals by bandpass sampling according to claim 3, wherein the available sampling range for the 2 spectrum signals in each obtainable combination is calculated by an equation of
$$\frac{{f}_{{C}_{n - m}} + ( {BW}_{m + n} / 2 )}{{r}_{m , n} + 1} \leq {f}_{{S}_{m , n}} \leq \frac{{f}_{{C}_{n - m}} - ( {BW}_{m + n} / 2 )}{{r}_{m , n}} , \\ where$$
$${f}_{{C}_{n - m}} = {f}_{{C}_{n}} - {f}_{{C}_{m}} , {BW}_{m + n} = {BW}_{m} + {BW}_{n} ,$$
and r represents a positioning rate of a bandwidth sum BWₘ₊ₙ of the 2 spectrum signals between the 2 spectrum signals, i.e.,
f_{L}_{ₙ}−f_{U}_{ₘ}
without an overlap.

8. The apparatus of down-converting RF multi-signals by bandpass sampling according to claim 7, wherein the r is an integer limited by an equation of
$$0 \leq {r}_{m , n} \leq ⌊ \frac{{f}_{{C}_{n - m}} - ( {BW}_{m + n} / 2 )}{{BW}_{m + n}} ⌋$$

9. A method of down-converting RF multi-signals by bandpass sampling, comprising:
setting up obtainable combinations of 2 spectrum signals extracted from 2N negative and positive spectrum signals existing for N RF signals;
calculating available sampling ranges for the 2 spectrum signals in each obtainable combination; and
determining an effective sampling range by the intersection of the available sampling ranges.

10. The method of down-converting RF multi-signals by bandpass sampling according to claim 9, further comprising selecting the minimum value of frequencies in the effective sampling range as a minimum sampling frequency after the step of determining the effective sampling range.

11. The method of down-converting RF multi-signals by bandpass sampling according to claim 9, wherein, when calculating available sampling ranges for the 2 spectrum signals in each obtainable combination, a first signal among the 2 spectrum signals disposed right in a frequency spectrum is moved left by a predetermined number, a lower limit frequency of the first signal is greater than an upper limit frequency of a second signal among the 2 spectrum signals disposed left in the frequency spectrum.

12. The method of down-converting RF multi-signals by bandpass sampling according to claim 9, wherein, when calculating available sampling ranges for the 2 spectrum signals in each obtainable combination, a first signal among the 2 spectrum signals disposed right in a frequency spectrum is moved left by a predetermined number, an upper limit frequency of the first signal is smaller than a lower limit frequency of a second signal among the 2 spectrum signals disposed left in the frequency spectrum.

13. The method of down-converting RF multi-signals by bandpass sampling according to claim 9, wherein a number of the obtainable combinations is _{2N}C₂=(2N!)/{(2N−2)!2!}.

14. The method of down-converting RF multi-signals by bandpass sampling according to claim 9, wherein the available sampling range for the 2 spectrum signals in each obtainable combination is calculated by an equation of
$$\frac{{f}_{{C}_{n - m}} + ( {BW}_{m + n} / 2 )}{{r}_{m , n} + 1} \leq {f}_{{S}_{m , n}} \leq \frac{{f}_{{C}_{n - m}} - ( {BW}_{m + n} / 2 )}{{r}_{m , n}} , \\ where$$
$${f}_{{C}_{n - m}} = {f}_{{C}_{n}} - {f}_{{C}_{m}} , {BW}_{m + n} = {BW}_{m} + {BW}_{n} ,$$
and r_{m,n} represents a positioning rate of a bandwidth sum BWₘ₊ₙ of the 2 spectrum signals between the 2 spectrum signals, i.e.,
f_{L}_{ₙ}−f_{U}_{ₘ}
without an overlap.

15. The method of down-converting RF multi-signals by bandpass sampling according to claim 14, wherein the r_{m,n} is an integer limited by an equation of
$$0 \leq {r}_{m , n} \leq ⌊ \frac{{f}_{{C}_{n - m}} - ( {BW}_{m + n} / 2 )}{{BW}_{m + n}} ⌋$$
